(19) United States
(12) Patent Application Publication
(10) Pub. No.: US 2026/0333009 A1
(43) Pub. Date: Oct. 22, 2026

(54) SYSTEMS AND METHODS FOR ENABLING EMERGENCY TEXT SERVICES FOR A ROAMING USER EQUIPMENT

(71) Applicant: Verizon Patent and Licensing Inc., Basking Ridge, NJ (US)

(72) Inventors: Amir SAGHIR, Frisco, TX (US); Edward AMOAH, Parsippany, NJ (US); Michael CHEN, Pittstown, NJ (US)

(73) Assignee: Verizon Patent and Licensing Inc., Basking Ridge, NJ (US)

(21) Appl. No.: 19/183,281

(22) Filed: Apr. 18, 2025

(51) Int. Cl. H04W 4/90; H04W 4/14

(52) U.S. Cl. CPC H04W 4/90; H04W 4/14

(57) ABSTRACT

A device, in a home network, may receive an emergency text message from a user equipment roaming on a visitor network, and may extract location data of the user equipment from the emergency text message. The device may provide an identifier and the location data of the user equipment to a location server of the home network. The device may cause the emergency text message, with the identifier of the user equipment, to be provided to a network device of the home network and to cause the network device to select a public safety answering point for the emergency text message based on the location data of the user equipment provided to the location server.

### BACKGROUND

The ability to quickly and reliably deliver text messages to emergency services is critical for public safety, especially as mobile devices have become the primary means of communication for many individuals.

### BRIEF DESCRIPTION OF THE DRAWINGS

FIGS. 1A-1D are diagrams of an example associated with enabling emergency text services for a roaming user equipment (UE).

FIG. 2 is a diagram of an example environment in which systems and/or methods described herein may be implemented.

FIG. 3 is a diagram of example components of one or more devices of FIG. 2.

FIG. 4 is a flowchart of an example process for enabling emergency text services for a roaming UE.

### DETAILED DESCRIPTION OF EXAMPLE EMBODIMENTS

The following detailed description of example implementations refers to the accompanying drawings. The same reference numbers in different drawings may identify the same or similar elements.

The advent of fourth generation (4G) and fifth generation (5G) telecommunications technologies has improved connectivity and service capabilities. However, when a UE that is a subscriber of a home network is roaming on a visitor (e.g., another carrier) network, the UE may be unable to send an emergency text message. The UE is unable send the emergency text message since a text control center (TCC), which is responsible for routing emergency text messages, resides within the home network and relies on an accurate location of the UE for forwarding the emergency text message to an appropriate public safety answering point (PSAP). The TCC may not receive an accurate location of the UE if the visitor network fails to support a UE location retrieval mechanism or is unable to communicate with the home network. This results in an inability to ensure that emergency text messages from roaming UEs are delivered to the nearest and most relevant emergency services (PSAPs), potentially impeding timely response in critical situations. Thus, current techniques for providing emergency service communications consume computing resources (e.g., processing resources, memory resources, communication resources, and/or the like), networking resources, and/or other resources associated with failing to provide location data associated with a roaming UE for routing an emergency text message, failing to identify the nearest emergency services for the roaming UE, handling the potentially catastrophic consequences associated with failing to support a party in an emergency situation, and/or the like.

Some implementations described herein enable emergency text services for a roaming UE. For example, a device (e.g., a call session control function (CSCF)), in a home network, may receive an emergency text message from a UE roaming on a visitor network, and may extract location data of the UE from the emergency text message. The device may provide an identifier and the location data of the UE to a location server of the home network. The device may cause the emergency text message, with the identifier of the UE, to be provided to a network device of the home network and to cause the network device to select a public safety answering point for the emergency text message based on the location data of the UE provided to the location server.

In this way, emergency text services may be facilitated for a roaming UE. For example, the implementations described herein streamline the process of determining an appropriate PSAP for an emergency text message sent from roaming UE. By extracting location data of the roaming UE from an emergency text message, and updating the location server with the location data, the implementations described herein may facilitate the efficient and accurate routing of emergency text messages to the nearest PSAP. The implementations may optimize the use of network resources by minimizing a need for broad queries across multiple PSAPs, and may reduce the potential for message misrouting due to incorrect location data. Thus, the implementations may conserve computing resources, networking resources, and/or other resources that would have otherwise been consumed by failing to provide location data associated with a roaming UE for routing an emergency text message, failing to identify the nearest emergency services for the roaming UE, handling the potentially catastrophic consequences associated with failing to support a party in an emergency situation, and/or the like.

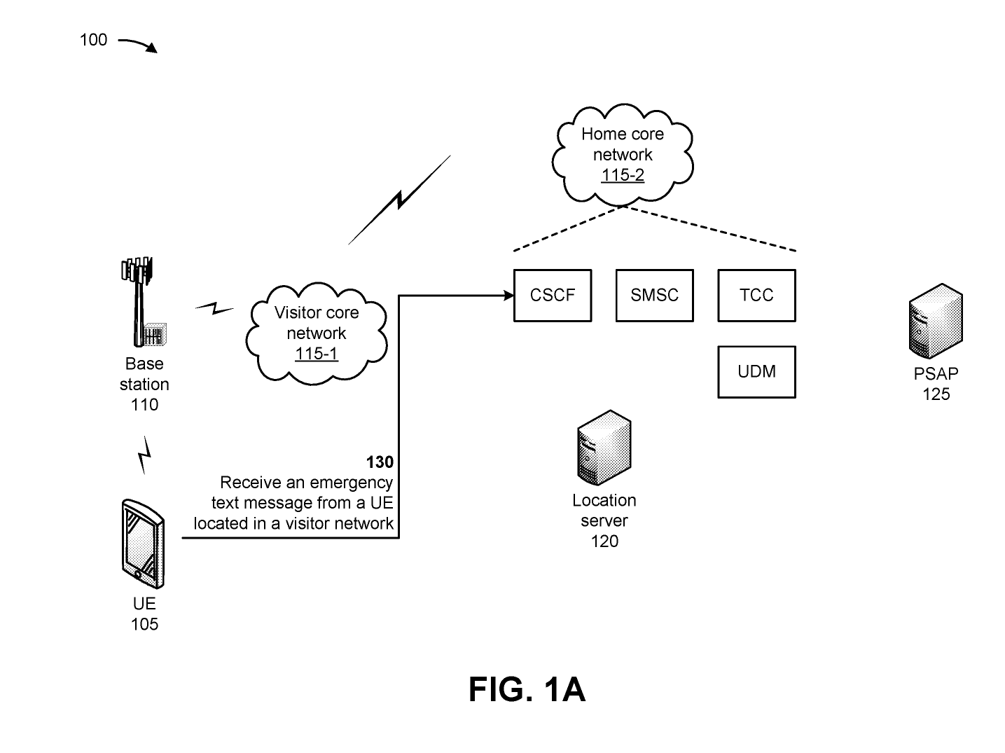

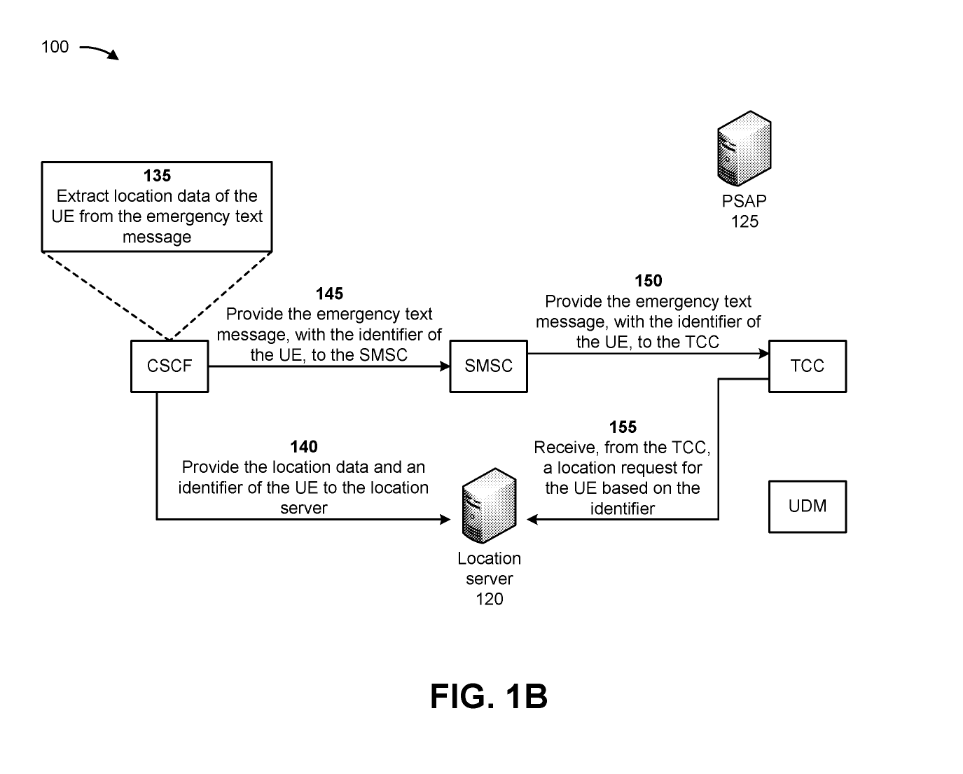

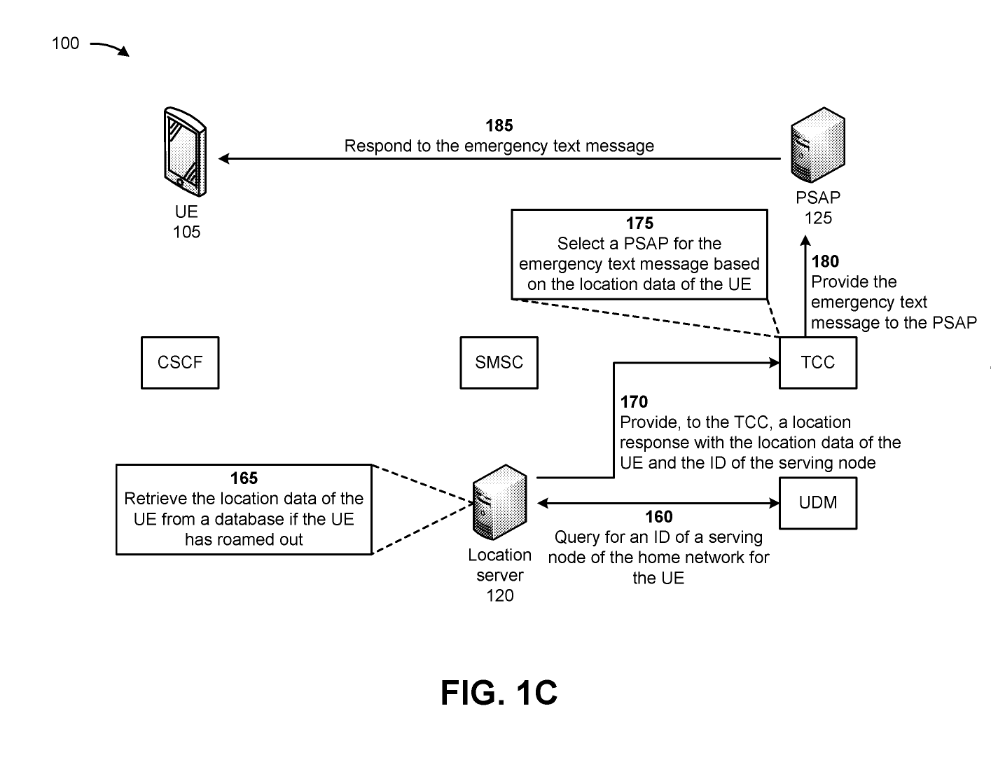

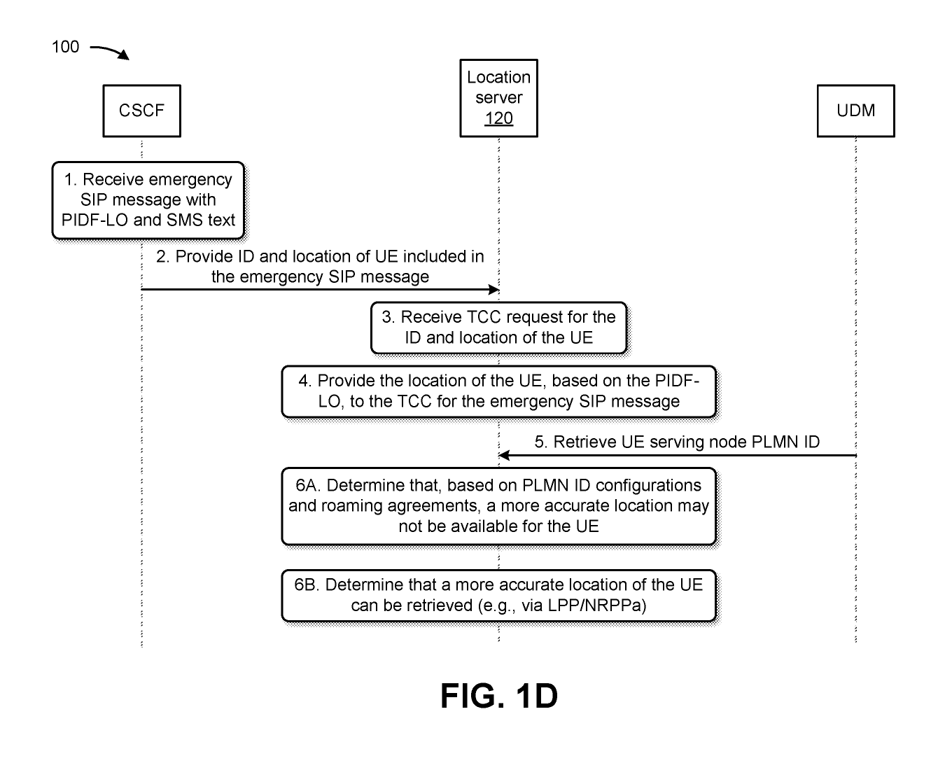

FIGS. 1A-1D are diagrams of an example 100 associated with enabling emergency text services for a roaming UE. As shown in FIGS. 1A-1D, example 100 includes a UE 105 associated with a base station 110, a visitor core network 115-1, a home core network 115-2, a location server 120, and a public safety answering point (PSAP) 125. The core network 115 may include the location server 120, a call session control function (CSCF), a short message service controller (SMSC), a text control center (TCC), and a unified data management (UDM) component. Further details of the UE 105, the base station 110, the core network 115 (e.g., the visitor core network 115-1 and the home core network 115-2), the location server 120, the PSAP 125, the CSCF, the SMSC, the TCC, and the UDM are provided elsewhere herein.

As shown in FIG. 1A, and by reference number 130, the CSCF may receive an emergency text message from the UE 105 located in a visitor network (e.g., the visitor core network 115-1). For example, the UE 105 (e.g., a mobile device) may roam from the home core network 115-2 to the visitor core network 115-1. A user of the UE 105 may cause the UE 105 to generate an emergency text message. The emergency text message may include a session initiation protocol (SIP) invite message that includes location information, e.g., a presence information data format location object (PIDF-LO), an identifier of the UE 105, and a short message service (SMS) text message. The PIDF-LO may include location data (e.g., global positioning system (GPS) coordinates) of the UE 105. The identifier of the UE 105 may include a unique identifier associated with the UE 105, such as an international mobile subscriber identity (IMSI), an international mobile equipment identity (IMEI), a temporary mobile subscriber identity (TMSI), a mobile subscriber integrated services digital network number (MSISDN), and/or the like. The SMS text message may include the text input by the user to the UE 105 and may be directed to an emergency service (e.g., a 911 service, a law enforcement service, an ambulance service, and/or the like).

The UE 105 may provide the emergency text message to the base station 110, and the base station 110 may route the emergency text message to the visitor core network 115-1. The visitor core network 115-1 may route the emergency text message to a network function (e.g., the CSCF) of the home core network 115-2, and the CSCF may receive the emergency text message. The emergency text message may initiate the sequence of steps that enables the proper routing of the emergency text message to an appropriate PSAP (e.g., the PSAP 125) based on the location data of the UE 105. The CSCF and other components of the home core network 115-2 may ensure that even when the UE 105 is roaming outside the home core network 115-2, the emergency text message can still be accurately directed to the nearest emergency services. In some implementations, functions described herein as being performed by the CSCF may be performed by one or more of a proxy CSCF (P-CSCF), a serving CSCF (S-CSCF), an interrogating CSCF (I-CSCF), a session border controller (SBC), a policy and charging rules function (PCRF), a home subscriber server (HSS), an access and mobility management function (AMF), and/or the like.

As shown in FIG. 1B, and by reference number 135, the network function (e.g., the CSCF) may extract location data of the UE 105 from the emergency text message. For example, the emergency text message may include the SIP invite message that contains the PIDF-LO with the location data of the UE 105, such as the GPS coordinates of the UE 105. The CSCF may extract the PIDF-LO from the emergency text message, and may identify the location data (e.g., the GPS coordinates) in the PIDF-LO. In some implementations, the CSCF may parse the SIP invite message to identify the PIDF-LO, and may extract the location data of the UE 105 from the PIDF-LO. The CSCF may extract the location data of the UE 105 to ensure that the location data of the UE 105 is available for further processing and routing of the emergency text message. In some implementations, the CSCF may also receive or extract the identifier (e.g., the IMSI, the IMEI, the MSISDN, and/or the like) from the emergency text message. In some implementations, the CSCF may parse the SIP invite message by identifying specific headers and payload sections within the SIP invite message where the PIDF-LO is embedded. The CSCF may utilize a predefined schema to decode the PIDF-LO and extract the GPS coordinates of the UE 105.

As further shown in FIG. 1B, and by reference number 140, the CSCF may provide the location data and an identifier of the UE 105 to a location server 120. For example, the CSCF may provide the location data and the identifier of the UE 105 to the location server 120, and the location server 120 may receive the location data and the identifier. In some implementations, the CSCF may provide the location data and the identifier of the UE 105 to the location server 120 using a representational state transfer (RESTful) application programming interface (API) call. The RESTful API call may include a request made to a service (e.g., provided by the location server 120) that adheres to the principles of representational state transfer (REST). The RESTful API call may utilize standard hypertext transfer protocol (HTTP) methods, such as GET, POST, PUT, DELETE, and PATCH, to perform operations on resources identified by uniform resource locators (URLs). The RESTful API call may include a request method, an endpoint URL, headers, and optionally a body containing data (e.g., the location data of the UE 105). In some implementations, the location server 120 may store the location data and the identifier of the UE 105 in a data structure (e.g., a database, a table, a list, and/or the like) associated with the location server 120.

As further shown in FIG. 1B, and by reference number 145, the CSCF may provide the emergency text message, with the identifier of the UE 105, to the SMSC. For example, the CSCF may forward the emergency text message, along with the identifier of UE 105, to the SMSC, and the SMSC may receive the emergency text message and the identifier of the UE 105. This may ensure that the emergency text message and the identifier of the UE 105 are handed off to the SMSC for subsequent processing. However, the CSCF does not provide the location data of the UE 105 to the SMSC since the CSCF and the SMSC serve different primary functions and operate within different contexts of the home core network 115-2. The CSCF may be responsible for the control and routing of SIP signaling messages within an IP multimedia subsystem (IMS) network of the home core network 115-2. The SMSC may be responsible for the delivery of SMS messages. The location data of the UE 105 may be managed by other network devices, such as the location server 120, the UDM, and/or the like. These network devices are designed to handle location-based services and provide location data when needed. Furthermore, forwarding the location data of the UE 105 involves privacy and security considerations. Location data is sensitive, and handling of location data is typically restricted to specific network devices designed to manage and protect such data.

As further shown in FIG. 1B, and by reference number 150, the SMSC may provide the emergency text message, with the identifier of the UE 105, to the TCC. For example, the SMSC may utilize a short message peer-to-peer protocol (SMPP) to provide the emergency text message and the identifier of the UE 105 identifier to the TCC. The TCC may receive the emergency text message and the identifier of the UE 105, and may store the emergency text message and the identifier of the UE 105 in a data structure associated with the TCC. The TCC may manage and control text-based communication services within the home core network 115-2. The TCC may facilitate efficient handling and delivery of text messages associated with various messaging services, such as SMS, multimedia message service (MMS), and other text-based communications. This may ensure that the emergency text message and the identifier of the UE 105 are handed off to the TCC for subsequent processing.

As further shown in FIG. 1B, and by reference number 155, the location server 120 may receive, from the TCC, a location request for the UE 105 based on the identifier. For example, when the TCC receives the emergency text message and the identifier of the UE 105, the TCC may generate a location request for the UE 105. The location request may include a request for the location data of the UE 105. The TCC may provide the location request to the location server 120, and the location server 120 may receive the location request from the TCC. The TCC may request the location data of the UE 105 so that the TCC may select a geographically closest PSAP to the location of the UE 105. Without the location data of the UE 105, the TCC may not intelligently select a PSAP for providing emergency services for the user of the UE 105.

As shown by FIG. 1C, and by reference number 160, the location server 120 may query the UDM for an identification of a serving node of the home network (e.g., the home core network 115-2) for the UE 105. For example, the location server 120 may query the UDM for a serving node (e.g., a network device) to obtain necessary information about a current network context of the UE 105. The UDM may store subscription data and user profiles associated with the UE 105, which may include details about the serving node currently serving the UE 105, such as an access and mobility management function (AMF) or a session management function (SMF). By querying the UDM, the location server 120 may retrieve up-to-date information about the serving node for the UE 105, and may ensure accurate and efficient location services. In some implementations, the location server may request, from the UDM, an identification of the serving node based on the identifier of the UE 105. For example, the location server 120 may need to determine the appropriate serving node to retrieve accurate location data of the UE 105.

As further shown in FIG. 1C, and by reference number 165, the location server 120 may retrieve the location data of the UE 105 from the data structure (e.g., a database) if the UE 105 has roamed out of the visitor core network 115-1. For example, if the UE 105 has roamed out of the visitor core network 115-1 (e.g., meaning that real-time location data of the UE 105 is unavailable), after the location server 120 received the location data of the UE 105, the location server 120 may retrieve the location data by accessing historical location data from the data structure. The historical location data may include last known location data for the UE 105 outside the home core network 115-2. This may ensure that even if real-time location data of the UE 105 is not available, the location server 120 may still provide the most recent known location data for the UE 105.

As further shown in FIG. 1C, and by reference number 170, the location server 120 may provide, to the TCC, a location response with the location data of the UE 105 and the identification of the serving node. For example, the location server 120 may generate a location response based on receiving the location request. The location response may include the location data of the UE 105 (e.g., whether provided by the CSCF or retrieved from the data structure) and an identifier of the serving node. In some implementations, the location server 120 may provide the location response, with the location data of the UE 105 and the identifier of the serving node, to the TCC, and the TCC may receive the location response. The location data of the UE 105 and the identifier of the serving node may enable the TCC to select an appropriate PSAP (e.g., the PSAP) for handling the emergency text message.

As further shown in FIG. 1C, and by reference number 175, the TCC may select a PSAP (e.g., the PSAP 125) for the emergency text message based on the location data of the UE 105 and/or the identifier of the serving node. For example, the TCC may utilize the location of the UE 105 and/or the identifier of the serving node to select a PSAP (e.g., the PSAP 125) from a plurality of PSAPs. In some implementations, may determine a geographically closest PSAP to the UE 105 based on the location data of the UE 105, and may select the geographically closest PSAP as the PSAP for handling the emergency text message. For example, using the location data of the UE 105, the TCC may determine which PSAP is a geographically closest PSAP to the location of the UE 105. This may ensure that the emergency text message is routed to the most relevant PSAP for providing emergency services.

In some implementations, the TCC may include one or more models that select a most geographically relevant PSAP based on the location data of the UE 105. The TCC may maintain a data structure that includes identifiers of PSAPs and their geographical coverage areas. The TCC may include one or more geospatial analysis functions to compare the location of the UE 105 with the PSAP data structure, ensuring that the emergency text message is routed to the nearest appropriate PSAP.

As further shown in FIG. 1C, and by reference number 180, the TCC may provide the emergency text message to the PSAP 125. For example, the TCC may select the PSAP 125 for the emergency text message based on the location data of the UE 105 and/or the identifier of the serving node. The TCC may provide the emergency text message, along with the location data of the UE 105, to the PSAP 125. The PSAP 125 may receive the emergency text message and may identify the UE 105 based on the identifier of the UE 105 associated with the emergency text message. The PSAP 125 may utilize the location data and the identifier of the UE 105 to communicate with the UE 105. This may ensure that the PSAP 125 receives all necessary data to respond to the emergency.

As further shown in FIG. 1C, and by reference number 185, the PSAP 125 may respond to the emergency text message. For example, the PSAP 125 may generate a response to the emergency text message, and may send a response to the UE 105 based on the location data and the identifier of the UE 105. In some implementations, the PSAP 125 may acknowledge receipt of the emergency text message with the UE 105, and may provide the UE 105 with instructions or assistance. For example, the PSAP 125 may send, to the UE 105, a response acknowledging receipt of the emergency text message and providing any necessary instructions or assistance to the user of the UE 105. Additionally, or alternatively, responding to the emergency text message may include the PSAP 125 communicating back to the UE 105, ensuring that the user knows that the emergency text message has been received and that emergency assistance is available.

In some implementations, the CSCF may receive an additional emergency text message from the UE 105, and may monitor for changes in the location data of the UE 105 based on the additional emergency text message. If the UE 105 moves to a different geographical location, the additional emergency text message may include new location data, and the CSCF may update the location server 120 with the new location data. Alternatively, if the UE 105 does not move to a different geographical location, the additional emergency text message may not include new location data, and the CSCF need not update the location server 120 with new location data.

FIG. 1D is an example information flow diagram associated with enabling emergency text services for a roaming UE 105. As shown at step 1 of FIG. 1D, the CSCF or another network function may receive an emergency SIP message with a PIDF-LO and an SMS text. For example, the CSCF may receive the emergency SIP message from the UE 105 that is roaming on the visitor core network 115-1. This may occur when a user travels abroad and connects to a local network that is different from a home network. The SIP message may include the PIDF-LO containing location data (e.g., GPS coordinates) of the UE 105 and the SMS text message intended for emergency services.

As shown at step 2 of FIG. 1D, the CSCF may provide, to the location server 120, an identifier (ID) and a location of the UE 105 that is included in the emergency SIP message. For example, the CSCF may extract the identifier and the location of the UE 105 from the PIDF-LO and may provide the identifier and the location of the UE 105 to the location server 120. This may ensure that the location server 120 has accurate information for processing the emergency request.

As shown at step 3 of FIG. 1D, the location server 120 may receive, from the TCC, a request for the identifier and the location of the UE 105. For example, the TCC may generate a request for the identifier and the location of the UE 105 to ensure that the emergency text message is routed to an appropriate PSAP. In some implementations, the TCC may provide the request for the identifier and the location of the UE 105 to the location server 120, and the location server 120 may receive the request.

As shown at step 4 of FIG. 1D, the location server 120 may provide the location of the UE 105, based on the PIDF-LO, to the TCC for the emergency SIP message. For example, based on the request, the location server 120 may provide, to the TCC, a response that includes the identifier and the location of the UE 105. This may ensure that the TCC has a current and accurate location of the UE 105. In some implementations, the TCC may utilize the location of the UE 105 to route the emergency text message to an appropriate PSAP.

A shown at step 5 of FIG. 1D, the location server 120 may retrieve a UE serving node public land mobile network identifier (PLMN ID) from the UDM. For example, the location server 120 may query the UDM to retrieve information about a serving node of the home core network 115-2 that is associated with the UE 105. In some implementations, the location server 120 may request identification of the UE serving node from the UDM, and the UDM may provide the PLMN ID of the serving node to the location server 120 based on the request. The location server 120 may utilize the identification of the UE serving node for determining network connections for the UE 105.

As shown step 6A of FIG. 1D, the location server 120 may determine that, based on PLMN ID configurations and roaming agreements, a more accurate location may not be available for the UE 105. For example, due to PLMN ID configurations and agreements, the location server 120 may determine that the location of the UE 105 (e.g., received from the CSCF) is the best location information that the location server 120 can retrieve. Thus, the location server 120 may determine that a more accurate location may not be available for the UE 105.

Alternatively, as shown at step 6B of FIG. 1D, the location server 120 may determine that a more accurate location of the UE 105 can be retrieved (e.g., via a long term evolution positioning protocol (LPP) and/or a new radio positioning protocol A (NRPPa)). For example, if conditions allow, the location server 120 may utilize advanced positioning protocols to obtain a more precise location for the UE 105. In some implementations, the location server 120 may ascertain that a more accurate location of the UE can be retrieved using LPP and/or NRPPa. Additionally, or alternatively, using the advanced positioning protocols such as LPP and NRPPa, the location server 120 may determine the more accurate location for the UE 105, and may provide the more accurate location of the UE 105 to the TCC.

In this way, emergency text services may be enabled for a roaming UE 105. For example, the implementations described herein streamline the process of determining an appropriate PSAP 125 for an emergency text message sent from a roaming UE 105. By extracting location data of the roaming UE 105 from an emergency text message, and updating the location server 120 with the location data, the implementations described herein may facilitate the efficient and accurate routing of emergency text messages to the nearest PSAP 125. The implementations may optimize the use of network resources by minimizing a need for broad queries across multiple PSAPs 125, and may reduce the potential for message misrouting due to incorrect location data. Thus, the implementations may conserve computing resources, networking resources, and/or other resources that would have otherwise been consumed by failing to provide location data associated with a roaming UE 105 for routing an emergency text message, failing to identify the nearest emergency services for the roaming UE 105, handling the potentially catastrophic consequences associated with failing to support a party in an emergency situation, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

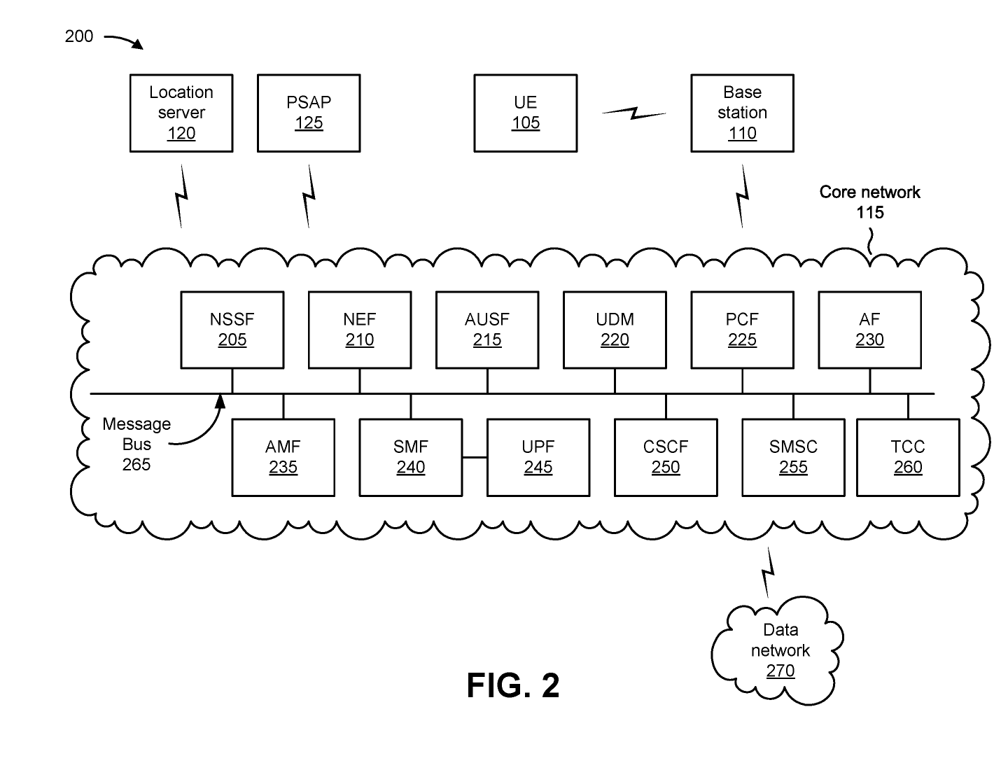

FIG. 2 is a diagram of an example environment 200 in which systems and/or methods described herein may be implemented. As shown in FIG. 2, the example environment 200 may include the UE 105, the base station 110, the core network 115, the location server 120, the PSAP 125, and a data network 270. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

The location server 120 may include one or more devices capable of receiving, generating, storing, processing, providing, and/or routing information, as described elsewhere herein. The location server 120 may include a communication device and/or a computing device. For example, the location server 120 may include a server, such as an application server, a client server, a web server, a database server, a host server, a proxy server, a virtual server (e.g., executing on computing hardware), or a server in a cloud computing system. In some implementations, the location server 120 may include computing hardware used in a cloud computing environment, such as one or more serverless components (e.g., one or more serverless functions). The location server 120 may be responsible for determining and managing the geographical location of the UE 105. The location server 120 may collect and process location data from various network elements, such as the base station 110 and components of the core network 115, to provide accurate and real-time location information. This information can be used for a variety of purposes, including emergency services, location-based services, network optimization, and lawful interception.

The PSAP 125 may include one or more devices capable of receiving, generating, storing, processing, providing, and/or routing information, as described elsewhere herein. The PSAP 125 may include a communication device and/or a computing device. For example, the PSAP 125 may include a server, such as an application server, a client server, a web server, a database server, a host server, a proxy server, a virtual server (e.g., executing on computing hardware), or a server in a cloud computing system. In some implementations, the PSAP 125 may include computing hardware used in a cloud computing environment, such as one or more serverless components (e.g., one or more serverless functions). The PSAP 125 may be responsible for receiving and processing emergency calls. When an emergency call is made, the PSAP 125 may be a first point of contact where trained personnel answer the call, gather critical information, and dispatch the appropriate emergency services, such as police, fire, or medical assistance.

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a UDM component 220, a policy control function (PCF) 225, an application function (AF) 230, an access and mobility management function (AMF) 235, a session management function (SMF) 240, a user plane function (UPF) 245, a CSCF 250, an SMSC 255, and/or a TCC 260. These functional elements may be communicatively connected via a message bus 265. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice examples for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane quality of service (QoS), among other examples.

The CSCF 250 includes one or more devices provided in an Internet protocol (IP) multimedia subsystem (IMS) architecture, which is used in 4G and 5G networks. The CSCF 250 may be responsible for managing and controlling the setup, maintenance, and termination of multimedia communication sessions, such as voice, video, and messaging services. The CSCF 250 may handle signaling between UEs 105 and an IMS core network, ensuring proper routing and delivery of services. The CSCF 250 may be divided into three types: a proxy-CSCF (P-CSCF), a serving-CSCF (S-CSCF), and an interrogating-CSCF (I-CSCF), each with specific roles in session management, user authentication, and service delivery.

The SMSC 255 includes one or more devices that are responsible for the routing, storage, and delivery of short message service (SMS) messages. When a text message is sent from the UE 105, the text message be transmitted to the SMSC 255, and the SMSC 255 may determine a destination and may ensure that the text message is delivered to a recipient UE 105. If the recipient UE 105 is unavailable (e.g., the recipient UE 105 is turned off or out of coverage), the SMSC 255 may store the text message and may retry delivery until the text message is successfully received. The SMSC 255 may also handle message status notifications, delivery reports, and other related functions, ensuring reliable and efficient text messaging services for UEs 105.

The TCC 260 includes one or more devices that manage and control the flow of text messages, such as SMS messages and multimedia messaging service (MMS) messages. The TCC 260 may oversee the routing, processing, and delivery of text messages, ensuring that the text messages reach their intended recipients efficiently and securely. The TCC 260 may perform tasks, such as message filtering, spam detection, content adaptation, and compliance with regulatory requirements. By managing these implementations, the TCC 260 may maintain the quality and reliability of text messaging services, supporting both user-to-user communication and application-to-person (A2P) messaging scenarios.

The message bus 265 represents a communication structure for communication among the functional elements. In other words, the message bus 265 may permit communication between two or more functional elements.

The data network 270 includes one or more wired and/or wireless data networks. For example, the data network 270 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

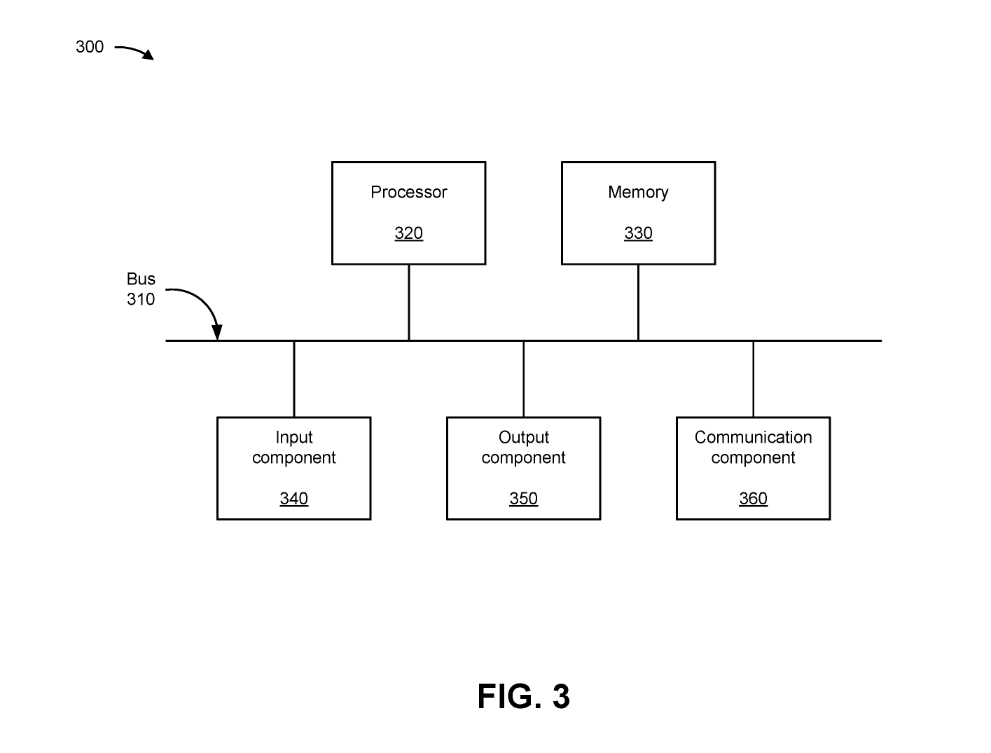

FIG. 3 is a diagram of example components of a device 300, which may correspond to the UE 105, the base station 110, the location server 120, the PSAP 125, the NSSF 205, the NEF 210, the AUSF 215, the UDM 220, the PCF 225, the AF 230, the AMF 235, the SMF 240, the UPF 245, the CSCF 250, the SMSC 255, and/or the TCC 260. In some implementations, the UE 105, the base station 110, the location server 120, the PSAP 125, the NSSF 205, the NEF 210, the AUSF 215, the UDM 220, the PCF 225, the AF 230, the AMF 235, the SMF 240, the UPF 245, the CSCF 250, the SMSC 255, and/or the TCC 260 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

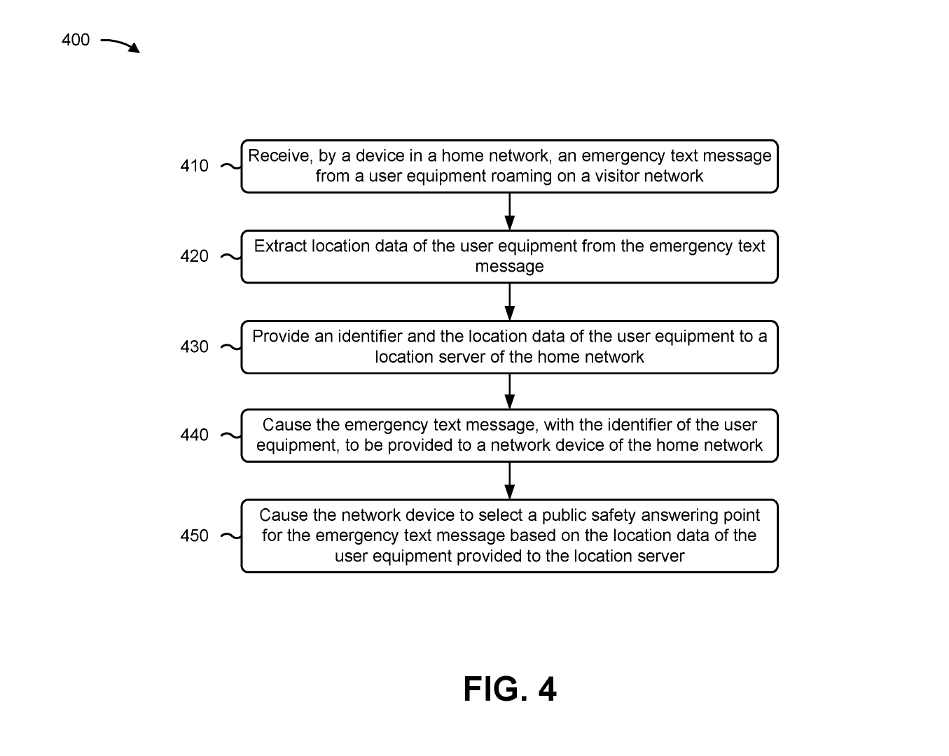

FIG. 4 is a flowchart of an example process 400 for enabling emergency text services for a roaming UE. In some implementations, one or more process blocks of FIG. 4 may be performed by a device (e.g., CSCF 250). In some implementations, one or more process blocks of FIG. 4 may be performed by another device or a group of devices separate from or including the device, such as a network device (e.g., the location server 120, the SMSC 255, the TCC, and/or the like) of the core network 115. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving an emergency text message from a UE roaming on a visitor network (block 410). For example, the device may receive an emergency text message from a UE roaming on a visitor network, as described above. In some implementations, the emergency text message is a SIP invite message that includes a request to deliver an SMS message to an emergency service. In some implementations, the device is a CSCF of the home network.

As further shown in FIG. 4, process 400 may include extracting, by the device, location data of the UE from the emergency text message (block 420). For example, the device may extract location data of the UE from the emergency text message, as described above. In some implementations, extracting the location data of the UE from the emergency text message includes extracting the location data of the UE from a SIP invite message. In some implementations, extracting the location data of the UE from the emergency text message includes extracting a PIDF location object from the emergency text message, wherein the PIDF location object includes the location data of the UE. In some implementations, the location data of the UE includes GPS coordinates of the UE.

As further shown in FIG. 4, process 400 may include providing an identifier and the location data of the UE to a location server of the home network (block 430). For example, the device may provide an identifier and the location data of the UE to a location server of the home network, as described above. In some implementations, the identifier is a unique identifier associated with the UE. In some implementations, providing the identifier and the location data of the UE to the location server includes providing the identifier and the location data of the UE to the location server using a representational state transfer API call.

As further shown in FIG. 4, process 400 may include causing the emergency text message, with the identifier of the UE, to be provided to a network device of the home network (block 440). For example, the device may cause the emergency text message, with the identifier of the UE, to be provided to a network device of the home network, as described above.

As further shown in FIG. 4, process 400 may include causing the network device to select a PSAP for the emergency text message based on the location data of the UE provided to the location server (block 450). For example, the device may cause the network device to select a PSAP for the emergency text message based on the location data of the UE provided to the location server, as described above. In some implementations, the PSAP is configured to communicate with the UE based on the identifier and the location data of the UE. In some implementations, the PSAP is located closer to the UE than other PSAPs, based on the location data of the UE. In some implementations, the network device is a TCC of the home network.

In some implementations, process 400 includes validating the location data of the UE against historical location parameters prior to providing the location data to the location server. In some implementations, process 400 includes receiving an additional emergency text message from the user equipment, monitoring for changes in the location data of the user equipment based on the additional emergency text message, and updating the location server with new location data when the UE moves to a different geographical location.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device in a home network, an emergency text message from a user equipment roaming on a visitor network;
extracting, by the device, location data of the user equipment from the emergency text message;
providing, by the device, an identifier and the location data of the user equipment to a location server of the home network; and
causing, by the device, the emergency text message, with the identifier of the user equipment, to be provided to a network device of the home network and to cause the network device to select a public safety answering point for the emergency text message based on the location data of the user equipment provided to the location server.

2. The method of claim 1, wherein the public safety answering point is configured to communicate with the user equipment based on the identifier and the location data of the user equipment.

3. The method of claim 1, wherein the emergency text message is a session initiation protocol invite message that includes a request to deliver a short message service message to an emergency service.

4. The method of claim 1, wherein extracting the location data of the user equipment from the emergency text message comprises:
extracting the location data of the user equipment from a session initiation protocol invite message.

5. The method of claim 1, wherein extracting the location data of the user equipment from the emergency text message comprises:
extracting a presence information data format location object from the emergency text message,
wherein the presence information data format location object includes the location data of the user equipment.

6. The method of claim 1, wherein providing the identifier and the location data of the user equipment to the location server comprises:
providing the identifier and the location data of the user equipment to the location server using a representational state transfer application programming interface call.

7. The method of claim 1, further comprising:
validating the location data of the user equipment against historical location parameters prior to providing the location data to the location server.

8. A device in a home network, the device comprising:
one or more processors configured to:
receive an emergency text message from a user equipment roaming on a visitor network,
wherein the emergency text message is a session initiation protocol invite message that includes a request to deliver a short message service message to an emergency service;
extract location data of the user equipment from the emergency text message;
provide an identifier and the location data of the user equipment to a location server of the home network; and
cause the emergency text message, with the identifier of the user equipment, to be provided to a network device of the home network and to cause the network device to select a public safety answering point for the emergency text message based on the location data of the user equipment provided to the location server.

9. The device of claim 8, wherein the one or more processors, to provide the identifier and the location data of the user equipment to the location server, are configured to:
provide the identifier and the location data of the user equipment to the location server using a representational state transfer application programming interface call.

10. The device of claim 8, wherein the public safety answering point is located closer to the user equipment than other public safety answering points, based on the location data of the user equipment.

11. The device of claim 8, wherein the device is a call session control function of the home network.

12. The device of claim 8, wherein the network device is a text control center of the home network.

13. The device of claim 8, wherein the one or more processors are further configured to:
validate the location data of the user equipment against historical location parameters prior to providing the location data to the location server.

14. The device of claim 8, wherein the one or more processors are further configured to:
receive an additional emergency text message from the user equipment;
monitor for changes in the location data of the user equipment based on the additional emergency text message; and
update the location server with new location data when the user equipment moves to a different geographical location.

15. A non-transitory computer-readable medium storing a set of instructions, the set of instructions comprising:
one or more instructions that, when executed by one or more processors of a device in a home network, cause the device to:
receive an emergency text message from a user equipment roaming on a visitor network;
extract location data of the user equipment from the emergency text message;
provide an identifier and the location data of the user equipment to a location server of the home network;
cause the emergency text message, with the identifier of the user equipment, to be provided to a network device of the home network and to cause the network device to select a public safety answering point for the emergency text message based on the location data of the user equipment provided to the location server;
receive an additional emergency text message from the user equipment;
monitor for changes in the location data of the user equipment based on the additional emergency text message; and
update the location server with new location data when the user equipment moves to a different geographical location.

16. The non-transitory computer-readable medium of claim 15, wherein the one or more instructions, that cause the device to extract the location data of the user equipment from the emergency text message, cause the device to:
extract the location data of the user equipment from a session initiation protocol invite message.

17. The non-transitory computer-readable medium of claim 15, wherein the one or more instructions, that cause the device to extract the location data of the user equipment from the emergency text message, cause the device to:
extract a presence information data format location object from the emergency text message,
wherein the presence information data format location object includes the location data of the user equipment.

18. The non-transitory computer-readable medium of claim 15, wherein the one or more instructions, that cause the device to provide the identifier and the location data of the user equipment to the location server, cause the device to:
provide the identifier and the location data of the user equipment to the location server using a representational state transfer application programming interface call.

19. The non-transitory computer-readable medium of claim 15, wherein the device is a call session control function of the home network, and the network device is a text control center of the home network.

20. The non-transitory computer-readable medium of claim 15, wherein the one or more instructions further cause the device to:
validate the location data of the user equipment against historical location parameters prior to providing the location data to the location server.
